(19) United States
(12) Patent Application Publication
(10) Pub. No.: US 2002/0125021 A1
(43) Pub. Date: Sep. 12, 2002

(54) Seal member for a valve assembly of a pneumatic nailer

(76) Inventor: Ming-Qun Tseng, Miaoli (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/798,969

(22) Filed: Mar. 6, 2001

(51) Int. Cl. B27C 3/08

(52) U.S. Cl. 173/169

(57) ABSTRACT

A valve assembly of a pneumatic nailer includes a ring received in the chamber and pin of a seal member extends through the ring and is connected to a trigger of the nailer. The seal member has a rod extending from a bottom thereof so as to engage with a first end of a spring. A second end of the spring is engaged with a locking member which is connected to the chamber. An annular seal extends from a top surface of the seal member so as to contact the bottom of the ring to seal the contact area between the ring the seal member.

### FIELD OF THE INVENTION

The present invention relates to a seal member for a valve assembly of a pneumatic nailer wherein the seal member has an annular seal embedded in a top surface thereof so as to contact a ring to seal the contact surface between the seal member and the ring.

### BACKGROUND OF THE INVENTION

A pneumatic nailer 10 is shown in FIG. 1 and the handle of the nailer 10 has a chamber 11 for receiving a valve assembly therein. The valve assembly includes a ring 20 which has a groove 21 defined in an outer periphery thereof so as to receive a seal ring 30 therein. A seal member 40 includes a disk 44 and a pin 41 extends from a top of the disk 44 and a rod 43 extends from a bottom of the disk 44. The pin 41 extends through the ring 20 and is connected to a push rod 14 of the trigger 13 of the nailer 10. The rod 43 is engaged with one end of a spring 50 and the other end of the spring 50 is engaged with a locking bolt 60 which is threadedly engaged with a threaded inner periphery 12 of the chamber 11. The locking bolt 60 has a passage 63 so as to be engaged with pneumatic hose. The disk 44 has a plurality of bosses 42 extending therefrom. When pulling the trigger 13, the pushing rod 14 pushes the pin 41 and the disk 44 is slightly inclined so as to allow pressurized air to enter into the nailer 10 via the gap between the disk 44 and the ring 20. However, after a period of time of use, the frequent contact between the bosses 42 and the ring 20 will scrub the underside of the ring 20 to result in worn-out on the underside of the ring 20. The worn-out results in leakage between the ring 20 and the seal member 40 and could mis-activate the nailer 10.

The present invention intends to provide a seal member that has an annular seal embedded in a top of the seal member so as to contact the ring to ensure the seal status between the ring and the seal member.

### SUMMARY OF THE INVENTION

In accordance with one aspect of the present invention, there is provided a valve assembly of a pneumatic nailer and comprising a ring received in the chamber and a seal member connected to a bottom of the ring. The seal member has a disk with a pin extending from a top surface of the disk and a rod extending from a bottom of the disk. An annular seal extends from the top surface of the disk. The pin extends through the ring and is connected to the push rod of the trigger. A first end of a spring is mounted to the rod and contacts the bottom of the seal member. A second end of the spring is engaged with a locking member which is connected to the chamber.

The primary object of the present invention is to provide a seal member with a flexible seal extending from a top surface of the seal member so as to contact the ring to prevent from leakage between the ring the seal member.

The present invention will become more obvious from the following description when taken in connection with the accompanying drawings which show, for purposes of illustration only, two preferred embodiments in accordance with the present invention.

### BRIEF DESCRIPTION OF THE DRAWINGS

FIG. 1 is a cross sectional view to show a conventional valve assembly of a pneumatic nailer;

FIG. 2 is an exploded view to show the conventional valve assembly of a pneumatic nailer;

FIG. 3 is a cross sectional view to show the ring and the seal member which is pushed to tilt an angle with pulling the trigger of the nailer;

FIG. 4 is a cross sectional view to show the valve assembly of the present invention;

FIG. 5 is a perspective view to show the seal member of the present invention;

FIG. 6 is a cross sectional view to show the seal member of the present invention;

FIG. 7 is a perspective view to show the ring of the present invention, and

FIG. 8 is a cross sectional view to show another embodiment of the seal member of the present invention.

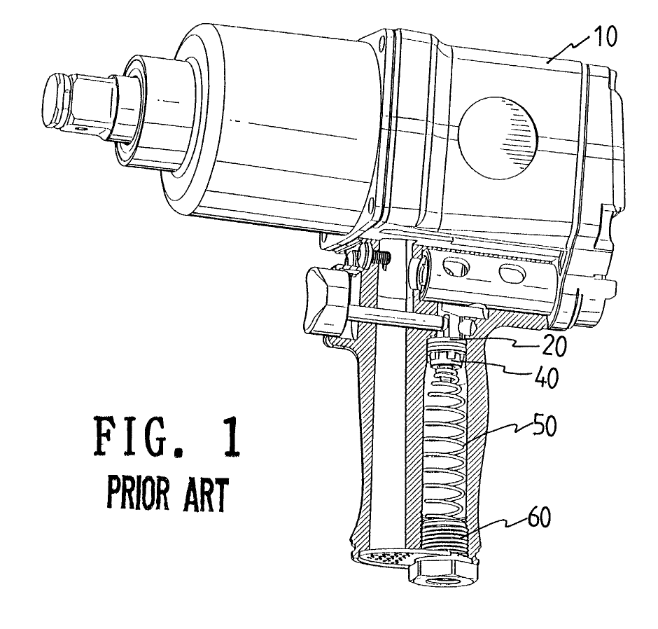

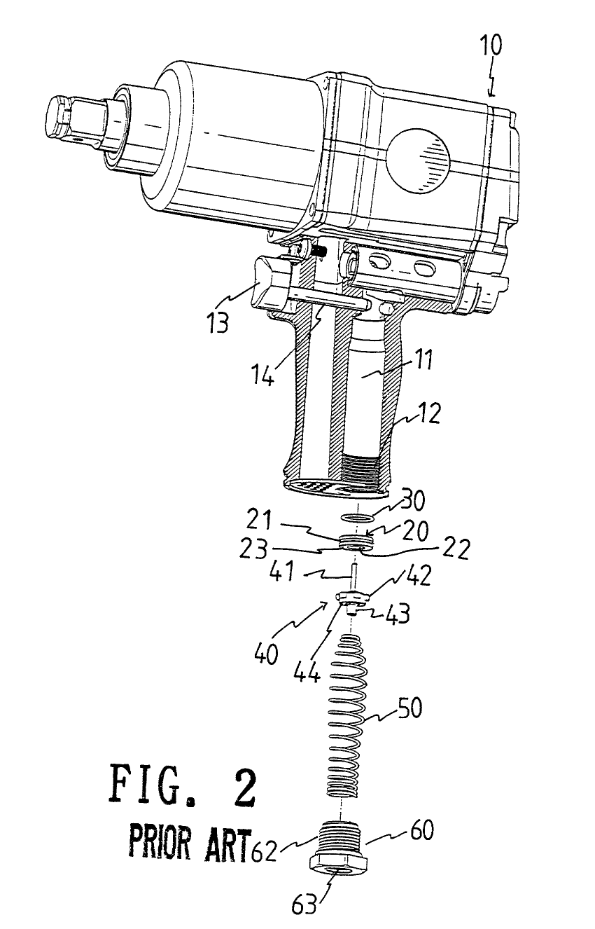

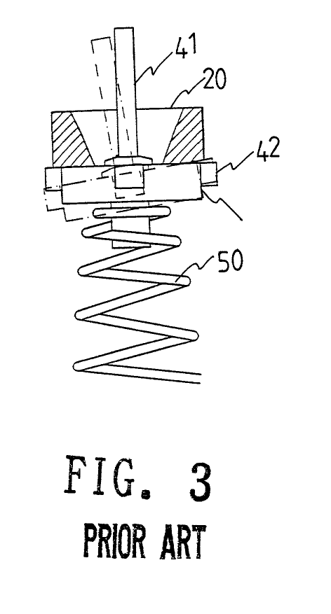

### DETAILED DESCRIPTION OF THE PREFERRED EMBODIMENT

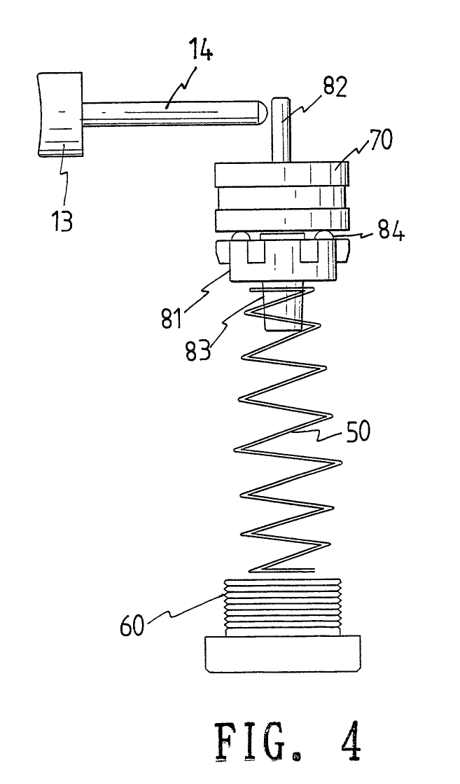

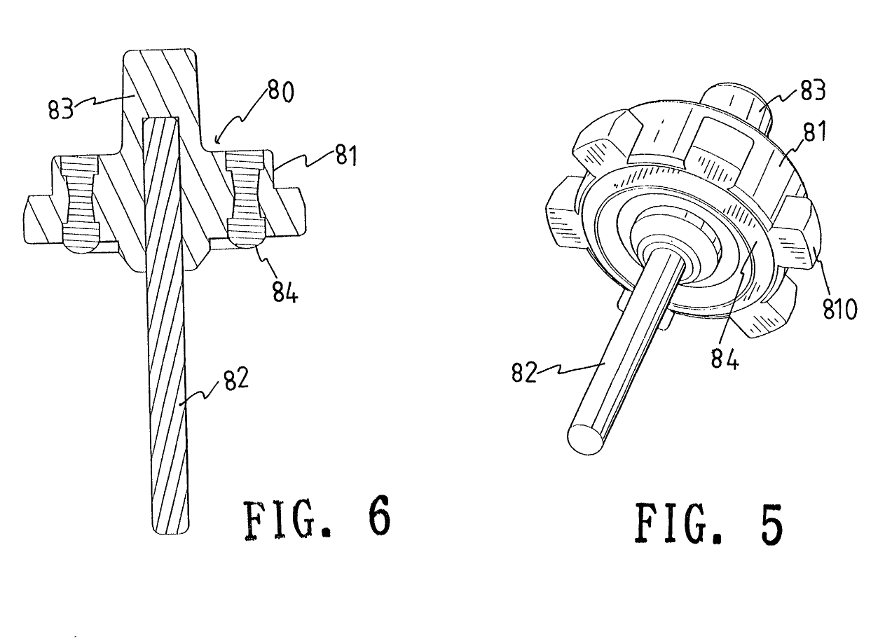

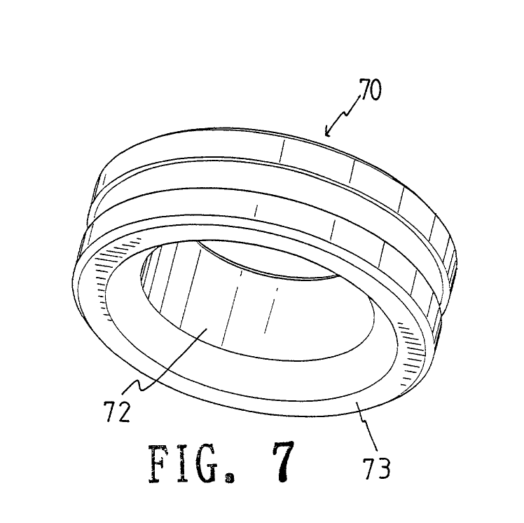

Referring to FIGS. 4 to 7, the valve assembly for a pneumatic nailer of the present invention comprises a ring 70 received in a chamber of the handle of the nailer and a seal member 80 is assembled to a bottom 73 of the ring 70. The seal member 80 includes a disk 81 with a pin 82 extending from a top surface of the disk 81 and a rod 83 extending from a bottom of the disk 81. The pin 82 extends through a central hole 72 in the ring 70 and is connected to a push rod 14 of the trigger 13 of the nailer. A plurality of bosses 810 extend from an outer periphery of the disk 81. An annular seal 84 extends from the top surface of the disk 81.

A first end of a spring 50 is mounted to the rod 83 and contacts the bottom of the seal member 80. A second end of the spring 50 is engaged with a locking member 60 which is engaged with the chamber. By the contact between the flexible annular seal 84 and the bottom 73 of the ring 70, the possibility of leakage between the seal member 80 and the ring 70 is reduced.

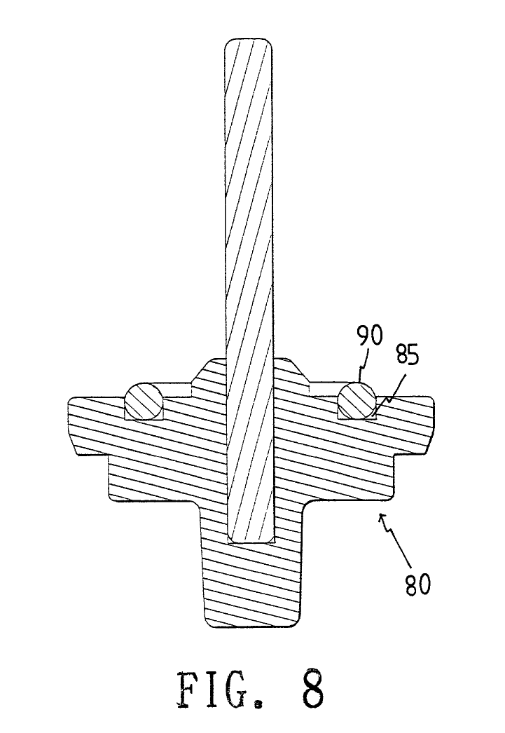

FIG. 8 shows another embodiment of the annular 90 wherein the disk 81 has a groove 85 defined in the top surface thereof and the annular seal 90 is engaged with the groove 85.

While we have shown and described various embodiments in accordance with the present invention, it should be clear to those skilled in the art that further embodiments may be made without departing from the scope of the present invention.

What is claimed is:

1. A valve assembly of a pneumatic nailer which has a chamber defined in a handle of said nailer and a trigger having a push rod movably extending in said chamber, said valve assembly comprising:
a ring adapted to be received in said chamber;
a seal member having a disk with a pin extending from a top surface of said disk and a rod extending from a bottom of said disk, an annular seal extending from said top surface of said disk, said pin extending through said ring and adapted to be connected to the push rod of the trigger, and
a first end of a spring mounted to said rod and contacting said bottom of said seal member, a second end of said spring engaged with a locking member which is adapted to be connected to the chamber.

2. The assembly as claimed in claim 1, wherein said disk has a groove defined in said top surface thereof and said annular seal is engaged with said groove.
